(19) United States
(12) Patent Application Publication
(10) Pub. No.: US 2024/0406109 A1
(43) Pub. Date: Dec. 5, 2024

(54) NETWORK TRAFFIC REDIRECTION SYSTEM AND ITS OPERATING METHOD

(71) Applicant: Damir Abdullovich Akhmetzhanov, Ulyanovskaya (RU)

(72) Inventor: Damir Abdullovich Akhmetzhanov, Ulyanovskaya (RU)

(21) Appl. No.: 18/674,315

(22) Filed: May 24, 2024

(30) Foreign Application Priority Data
May 29, 2023 (RU) 2023113914

(51) Int. Cl. H04L 47/122; H04L 47/125

(52) U.S. Cl. CPC H04L 47/122; H04L 47/125

(57) ABSTRACT

A network traffic redirection system includes a server connected to a plurality of routers and a plurality of modems. The plurality of the routers are connected to the plurality of modems. The server, the plurality of the routers, and the plurality of the modems are connected to establish an internal subnet, wherein the server, the plurality of the routers, and the plurality of the modems have internal IP addresses. Each subset of the routers is connected to a corresponding subset of the modems, the server includes at least one software proxy server and at least one L2TP server. The server has an externally accessible IP address, while the routers have only internal IP addresses. The server and the plurality of the routers are connected using a tunnel allowing an operation of the internal subnet between the server and the routers.

### TECHNICAL FIELD OF THE INVENTION

The present invention is related to the field of large-scale networks and highly branched networks, and more particularly, to the network technologies for redirecting Internet traffic.

### DESCRIPTION OF RELATED ART

Traditionally, designing a traffic-redirecting network system requires an external (accessible via the Internet) IP address to be assigned to the router that manages mobile broadband modems. A common approach is to use a powerful computing device as the router to concurrently handle the operation of a software proxy server, which receives traffic on one of its logical network ports, redirects it through the network interface of a specified connected broadband modem, and then returns the result to the client.

This approach requires compliance with a set of conditions (such as the availability of an external IP address and excessive computational power of the router), which can be impossible or unreasonable to achieve in practice, thereby limiting the expansion of the network system infrastructure. For instance, in cases when the Internet service provider cannot provide an externally accessible IP address, the use of the network system cannot be reached. This implication results in the software proxy server being unable to receive connections and traffic as these would be filtered at the level of the upstream network equipment of the Internet service provider.

Additionally, it is common to assign the role of a router capable of running software proxy servers to a personal computer with computational power exceeding the minimum requirements for such software, therefore leading to the increased energy consumption of particular nodes in the network system.

Several systems are known that are comparable in functionality but perform similar tasks through different methods. For example, several implementations of Multi-WAN systems execute the “summing up” of various outgoing Internet access channels to achieve greater bandwidth and improve overall access quality. Known systems aim to concurrently use multiple outgoing connections to form a unified connection between the server and the requested resource. In contrast, the suggested invention aims to establish the maximum number of connections from different network devices (with different external IP addresses) to any number of resources.

Also, there are several known solutions for organizing VPN services that provide access to Internet resources on behalf of other servers. These connection-organizing schemes generally involve the direct use of the same device for receiving incoming client connections and sending outgoing connections to addresses requested by clients.

This approach has several drawbacks, which the present invention addresses: each server is an independent powerful computing device providing most of its functionality solely at its network level; each server has a limited number of known IP addresses belonging to hosting service providers which negatively impacts client pre-assessment and frequently leads to additional robot checks; the requirement for each separate server to have an externally available IP address to accept connections from clients still applies; no control over the transmitted traffic is established, and ensuring sufficient security is challenging since the incoming traffic is usually encrypted and transmitted at lower levels of the OSI model, preventing the access denial for unsafe resources and/or clients.

Known are a packet routing system and method (US20070121579A1, published on 2012 Sep. 4). The known solution discloses a flexible, scalable hardware and software platform that allows a service provider to easily provide Internet services, virtual private network services, firewall services, etc., to a plurality of customers. One aspect provides a method and system for delivering security services. This includes connecting a plurality of processors in a ring configuration within a first processing system, establishing a secure connection between the processors in the ring configuration across an Internet protocol (IP) connection to a second processing system to form a tunnel, and providing both router services and host services for a customer using the plurality of processors in the ring configuration and using the second processing system, a packet routing system and method is described that includes a processor identifier in each packet to route the packets to a physical processor, and a logical queue identifier to route the packets to the destination object within that processor.

However, the above solution implements a different network topology that does not allow optimization of energy consumption and efficient distribution of traffic across a plurality of output modems.

High data rate wireless packet data communications system (U.S. Pat. No. 6,894,994B1, published on 2005 May 17) is known and considered to be the closest prior art. This wireless packet data communications system includes a number of modem pool transceivers (MPTs), one or more modem pool controllers (MPCs), and one or more servers. Each MPT receives and processes data packets to generate a modulated signal (e.g., a CDMA spread spectrum signal) suitable for transmission over a terrestrial communications link. Each MPC provides call related processing for one or more MPTs. The servers couple to the MPTs and MPCs via an Internet Protocol (IP) back-bone and provide management of the communications system. The IP back-bone further interconnects the MPTs with one or more data networks and includes a number of routers that route data packets between the data networks and the MPTs. Each MPT can couple to two or more routers for redundancy. Each MPT is operated as an element in an IP network and is associated with an IP address that identifies the MPT. One to three MPTs can be deployed at each cell site to provide wireless data service coverage for up to three sectors at the cell site. The MPCs can either be centralized and coupled to the MPTs via the IP back-bone or distributed about the communications system.

The above solution uses elements of the proposed network topology. However, it lacks a server that distributes traffic across the routers, resulting in the use of multiple external IP addresses and limiting the potential to improve network energy efficiency and scalability.

### SUMMARY OF THE INVENTION

The problem addressed by the present invention is to implement an externally accessible network system for redirecting Internet traffic through mobile broadband modems, eliminating the drawbacks of known systems and allowing wide scalability of the developed solution. The invention also enables the load distribution of software proxy servers onto individual physical computing devices with external IP addresses upon necessity.

The essence of the invention is to create a virtual subnet consisting of a server and a plurality of routers, connecting the server with an external IP address to child routers. This server ensures the uninterrupted operation of software proxy servers and manages the redirection of Internet traffic within the virtual subnet at its level. The router routes the received traffic from the virtual subnet to modems and further into the Internet. The above-mentioned network system server operates as the root node and ensures the functioning of the other nodes within the virtual subnet. The utilization of such a virtual subnet structure allows the use of hardware with sufficient processing power for the tasks and offloads child nodes' processes to the root node within the virtual subnet while improving the overall energy efficiency of the solution compared to known solutions. Additionally, the system requires only one external IP address.

Technical results achieved by the present invention are concluded in the elimination of the need to obtain external IP addresses from Internet service providers. That therefore enables the deployment of endpoint hardware in previously inaccessible locations. Furthermore, the redistribution of computational load and the replacement of overly powerful endpoint hardware with alternatives having sufficient capabilities to fulfill the assigned tasks significantly increases the overall energy efficiency of the system.

### BRIEF DESCRIPTION OF THE DRAWINGS

FIG. 1—Network diagram with a single user device and one router.

FIG. 2—Network diagram with a plurality of the user devices and routers.

FIG. 3—Server diagram.

FIG. 4—Router diagram.

### DETAILED DESCRIPTION

The present invention is proposed to address the aforementioned issues and aims to ensure the operation of the end node of the network system using any methods of Internet connectivity while reducing the technical requirements for the end nodes of the network system. This is achieved by distributing a significant portion of the computational load to the higher-level nodes of the network system.

The task is solved by creating a virtual subnet that connects the server with an external IP address to child routers to which modems are connected. The server ensures uninterrupted operation of the software proxy servers and manages the redirection of Internet traffic within the virtual subnet at its level. This node in the network system serves as the root and allows the functioning of other nodes within the virtual subnet.

The use of such a server in the structure makes centralized control of client access possible, utilizing industrial-grade equipment with sufficient power to fulfill its tasks, and distributing the load from other nodes in the virtual subnet. This approach enhances the overall energy efficiency of the invention in comparison to existing solutions. As a result, the system's security is improved by implementing access control and access restriction systems for individual resources on the Internet at the level of software proxy servers, operating at higher levels of the OSI model and enabling control over a significant part of client behavior. Importantly, this functionality has a minimal impact on the energy consumption of network elements.

A user device connects to the server via the server's external IP address using a specific port through which software proxy servers accept the connection. The user's connection is then redirected into the internal subnet to a specific router, which routes the traffic to a modem and into the Internet. As the software proxy server is no longer required at the router level, only the redirection of intranet traffic between the server, router, and modems is maintained in the user-inaccessible segment of the network system. This approach reduces the computational resource requirements for the endpoint hardware. Additionally, upgrading endpoint hardware to meet new computational power requirements contributes to higher overall energy efficiency. The use of a virtual subnet eliminates the need to obtain an external IP address from an Internet service provider, allowing the deployment of the endpoint hardware in locations without a direct access to Internet.

A mobile broadband modem, preferably connected via a USB interface, is controlled by a router and allows the reception and transmission of Internet traffic through the mobile network of a cellular service provider. Within the scope of the invention, it is viable to use a plurality of modems, each managed by a router and functioning within the network system to receive and transmit Internet traffic through mobile networks of cellular service providers. In case of using the plurality of the modems, each modem is leased an outgoing IP address within the cellular service provider's network. The use of the mobile modems being operated in optimal mode leads to a reduction in energy consumption for the end nodes and the entire system. Load optimization on the modem is achieved by configuring the server to direct only the authorized (optimal) volume of user device's traffic to the modem. A modem may consume around 6 W under maximum load, it can be reduced to approximately 3 W if operating under optimal conditions. The designed network configuration enables optimal load distribution, minimizing both the number of network elements and providing the flexible configuration for these network elements for the most energy-efficient operation.

Within the network system, client traffic (traffic from the user device) is received at the server with an external IP address and then redirected into the virtual subnet using the intranet IP address of the router. The router routes the received traffic within the virtual subnet through the broadband mobile modem. The modem transmits the traffic through the cellular network of the service provider on its behalf and from its IP address. The response from the target website (server/computer) is returned to the modem, which sends it back to the child device, from where it is directed to the root node of the network system and subsequently sent to the client.

The network system's operation results in connecting the user device to nodes on the Internet through a broadband mobile modem placed in any location with an Internet connection. The invention improves the energy efficiency of the system, reduces requirements for the endpoint hardware, redistributes computational loads according to specific tasks performed by individual nodes, ensures the security of the system through control of incoming user traffic at the level of software proxy servers, and eliminates additional requirements for the end Internet service provider (specifically, a dedicated, external, white IP address) by organizing a virtual subnet between end nodes and the server.

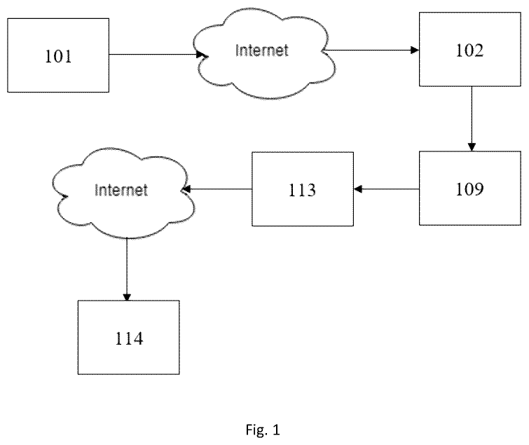

FIG. 1 illustrates the following network elements:
101—User device requesting access to the target website (server/computer),
102—Server,
109—Router,
113—Modem,
114—Target website (server/computer).

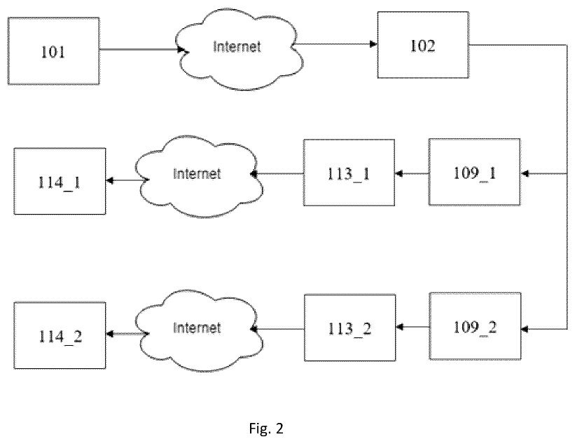

FIG. 2 shows the same elements, with the designation of some parts of certain nodes containing indices separated from the main number by an underscore. Indices only denote the ordinal number of identical nodes and do not have any additional meaning.

Preferred embodiments for implementing the present invention will be described with reference to the accompanying drawings.

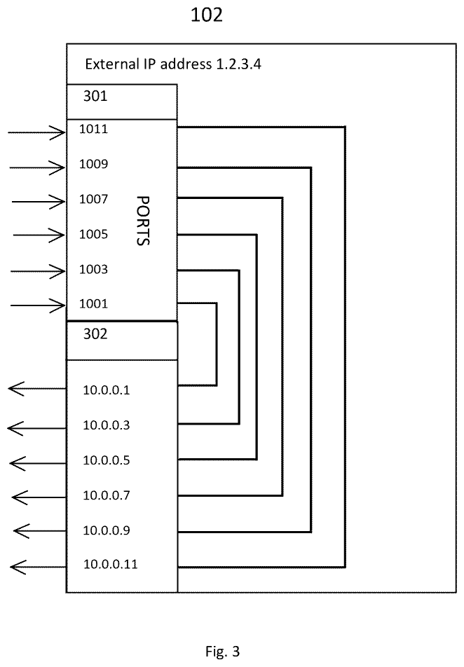

FIG. 3 illustrates the diagram of server 102 comprising a proxy server 301 and an L2TP server 302.

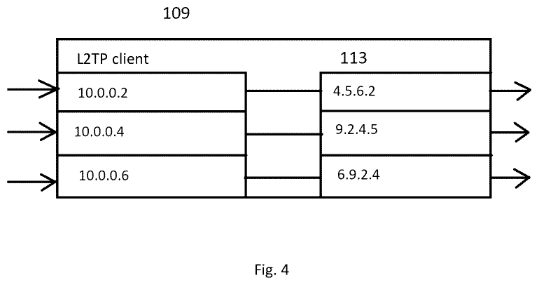

FIG. 4 illustrates the diagram of router 109 with modems 113.

The direction of the arrows on the drawings indicates one of the message exchange stages (from server 102 to the modems 113), but a person skilled in the art should understand that the message exchange occurs in both directions.

### The First Embodiment

As illustrated in FIG. 1, the network system comprises a single server 102 with an external IP address 1.2.3.4, hosts a proxy server on port 1000, establishes an internal subnet, and serves as an L2TP server with an address of 10.0.0.1 within this subnet. The system also includes a child router 109, serving as an L2TP client, connecting to the L2TP server, and having an IP address of 10.0.0.2 in the subnet. The child router manages a modem 113 having an IP address of 4.3.2.1 assigned by the mobile network operator.

In this embodiment of the network system device 101 establishes a connection to the proxy server on port 1000 via the Internet using the external IP address 1.2.3.4 of server 102. After successfully establishing a connection between device 101 and the proxy server, traffic from device 101 is redirected from the external network through the L2TP tunnel to the child router 109. On the child router 109, traffic is received at the internal IP address 10.0.0.2 and routed to the modem 113, which has the IP address 4.3.2.1. The modem 113 routes the traffic to the Internet to the target website (server/computer), which returns a response to the modem 113. The child router 109 routes the response from modem 113 through the L2TP client to server 102, which receives the response at IP address 10.0.0.1 and sends it to the proxy server. The proxy server, in turn, sends the response to the user device 101.

The session between the L2TP server of server 102 and the L2TP client of the child router 109 is established once and is restored in case of unexpected disruptions, inducing enhancement of overall system stability, improvement of the user experience, and reduction of manual control.

The session between client 101 and the target website is established and closed at the request of client 101, and the traffic redirection occurs within the protocol selected by client 101.

### The Second Embodiment

As illustrated in FIG. 2, FIG. 3, and FIG. 4, the network system comprises a single server 102 with an external IP address 1.2.3.4. The server hosts six proxy servers 301 on ports 1001, 1003, 1005, 1007, 1009, and 1011, establishes an internal subnet, and implements the functions of an L2TP server 302 with IP addresses 10.0.0.1, 10.0.0.3, 10.0.0.5, 10.0.0.7, 10.0.0.9, 10.0.0.11 within this subnet. The system also includes two child routers 109 (FIG. 2 shows and describes the use of two routers 109, but their number may be greater in practice), serving as L2TP clients, connecting to the L2TP server 302, and having the following IP addresses in the subnet:
1. The first child router 109 (shown in FIG. 4)—10.0.0.2, 10.0.0.4, 10.0.0.6.
2. The second child router 109 (not shown in the drawings)—10.0.0.8, 10.0.0.10, 10.0.0.12.

The child routers 109 manage the modems 113 connected thereto:
1. The first child router 109 manages the modems 113 with external IP addresses: 6.9.2.4, 9.2.4.5, 4.5.6.2.
2. The second child router 109 manages the modems 113 (not shown in the drawings) with external IP addresses: 4.3.2.1, 5.6.7.9, 3.5.6.2.

In this embodiment of the network system, user device 101 (in practice, the network system exchanges data with multiple devices 101) connects to proxy servers 301 over the Internet via predefined ports using the external IP address 1.2.3.4 of the server 102. After successfully establishing a connection between the user device 101 and the proxy server 301, traffic from device 101 is redirected from the external network through the L2TP tunnel (representing a virtual cable laid through public networks) to a specified child router 109 via the IP address linked to the router 109 and the L2TP server 302. On the child router 109, traffic is received at one of the internal IP addresses and routed to the specific modem 113 with a designated external IP address according to routing rules. The modem 113 routes the traffic to the target website (server/computer) on the Internet, which returns a response to the modem 113. The child router 109 routes the response from modem 113 through the L2TP client to server 302, which receives the response at the original IP address within the internal subnet and sends it to the proxy server 301. The proxy server, in turn, sends the response to the user device 101.

The session between the L2TP server 302 of server 102 and the L2TP client of the child router 109 is established once and restored in case of unexpected interruptions.

The session between device 101 and the target website (server/computer) is initiated and terminated at the request of device 101, and the traffic redirection occurs within the protocol selected by device 101.

The embodiment enables scaling the network system in the following dimensions:
1. On server 102: up to the exhaustion of available external ports, up to the exhaustion of IP addresses in non-public subnets, within the allocated bandwidth of Internet connection.
2. On the child router 109: up to the exhaustion of resources of the controller managing the broadband access modems 113, within the allocated bandwidth of Internet connection.

In case of resource exhaustion of any node in the network system, horizontal scaling is suggested:
1. If the resources of the child router 109 are exhausted, it is possible to install another child router 109, using the existing Internet connection.
2. If the Internet connection resources are exhausted, it is possible to use one or more modems 113 as the primary connection to the Internet, as the network system does not require an externally accessible IP address.
3. If the resources of server 102 are exhausted, it is possible to install another server 102 and transfer control of some child routers 109 to the new server 102.

The singular mentioned elements do not exclude the plurality of respective elements unless otherwise specified.

The methods disclosed herein comprise one or more stages or actions to implement the described method. The method's stages and/or actions are considered interchangeable without exceeding the scope of the invention's claims. In other words, if a specific order of stages or actions is not defined, the order and/or use of specific stages and/or actions may vary without exceeding the scope of the invention's claims.

The application does not indicate specific software and hardware implementations for embodying the blocks in the drawings, but those skilled in the art should understand that the essence of the invention is not limited to any specific software or hardware implementation. Therefore, any software and hardware means known in the art may be used to implement the invention. Hardware may be implemented in one or more specialized integrated circuits, digital signal processors, devices for digital signal processing, programmable logic devices, user-programmable gate arrays, processors, controllers, microcontrollers, microprocessors, electronic devices, other electronic modules configured to perform the functions which were described in this document, a computer, or a combination of the above.

Despite the detailed description and illustrations of exemplary embodiments provided in the accompanying drawings, it should be understood that such embodiments are explanatory and are not intended to limit the broader invention. The present invention should not be restricted specifically to shown and described arrangements and constructions, as various other modifications may be apparent to those skilled in the art.

Features mentioned in various dependent claims, as well as implementations disclosed in various portions of the description, may be combined to achieve advantageous effects, even if the possibility of such combination is not explicitly disclosed.

1. A network traffic redirection system comprising:
a server connected to a plurality of routers,
the plurality of the routers connected to a plurality of modems,
the plurality of the modems,
characterized in that
the server, the plurality of the routers, and the plurality of the modems are connected to establish an internal subnet, wherein the server, the plurality of the routers, and the plurality of the modems have internal IP addresses, wherein each subset of the routers is connected to a corresponding subset of the modems, the server includes at least one software proxy server and at least one L2TP server;
the server has an externally accessible IP address, while the routers have only internal IP addresses;
the server and the plurality of the routers are connected using a tunnel allowing an operation of the internal subnet between the server and the routers;
the server is configured to receive data on ports of the software proxy servers from a user device accessing thereof through the external IP address, and to direct the data to the routers via an L2TP tunnel within the internal subnet using the L2TP server;
the routers are configured to route the data received from the server to the connected modems, and
the modems are configured to send the data received from the router to an external network node, access to which was requested by the user device from the server.

2. The system of claim 1, wherein the router has a plurality of internal IP addresses within the internal subnet, the router is configured to manage the plurality of the modems and route the received data from the server to the modem corresponding to one of the internal IP addresses in accordance to the instructions from the server.

3. The system of claim 1, wherein the modem is a mobile modem.

4. The system of claim 1, wherein the server has a plurality of IP addresses within the internal subnet and multiple proxy servers configured to send incoming traffic to the router with a specific IP address within the internal subnet.

5. A method for redirecting Internet traffic comprising:
organizing a network structure consisting of a server connected to a plurality of routers connected to a plurality of modems,
characterized in that
the server, the plurality of the routers, and the plurality of the modems establish an internal subnet, wherein the server, the plurality of the routers, and the plurality of the modems have internal IP addresses, wherein each subset of the routers is connected to a corresponding subset of the modems, the server has an externally accessible IP address, while the routers have only internal IP addresses, the server includes at least one software proxy server and at least one L2TP server;
establishing a connection between the server and the plurality of the routers using an L2TP tunnel allowing an operation of the internal subnet between the server and routers;
using virtual proxy servers, the server receives data from user devices accessing it via the external IP address and sends the data to the routers via the L2TP tunnel within the internal subnet, using the L2TP server.
routing the data received from the server with the router to the connected modems;
sending the data received from the router with the modem to an external network node, access to which was requested by the user device from the server.

6. The method of claim 5, wherein the server is configured to balance the load within the internal network to reduce power consumption within the internal network.
